(19) United States
(12) Patent Application Publication
(10) Pub. No.: US 2013/0042278 A1
(43) Pub. Date: Feb. 14, 2013

(54) METHOD AND APPARATUS FOR PROVIDING VIDEO SERVICE

(71) Applicants: Seok Ho WON, Daejeon (KR); Sun Hyoung KWON, Seoul (KR); Ho Kyom KIM, Daejeon (KR); Jong Soo LIM, Daejeon (KR); O Hyung KWON, Daejeon (KR)

(72) Inventors: Seok Ho WON, Daejeon (KR); Sun Hyoung KWON, Seoul (KR); Ho Kyom KIM, Daejeon (KR); Jong Soo LIM, Daejeon (KR); O Hyung KWON, Daejeon (KR)

(73) Assignee: Electronics and Telecommunications Research Institute, Daejeon (KR)

(21) Appl. No.: 13/569,603

(22) Filed: Aug. 8, 2012

(30) Foreign Application Priority Data
Aug. 8, 2011 (KR) 10-2011-0078772
Apr. 5, 2012 (KR) 10-2012-0035209

(51) Int. Cl. H04N 21/61

(52) U.S. Cl. 725/62

(57) ABSTRACT

A method and an apparatus for providing video service according to example embodiments of the present invention are disclosed. The method for providing video service according to one example embodiment of the present invention comprises determining based on a predetermined reference whether it is necessary to set multiple bearers to provide the video service for a terminal, and when it is determined necessary to set the multiple bearers, setting an additional bearer, dividing a video source stream into a first stream and a second stream, assigning the first and second streams to a default bearer and the additional bearer, respectively, and transmitting the first and second streams to the terminal.

### CLAIM FOR PRIORITY

This application claims priority to Korean Patent Application No. 10-2011-0078772 filed on Aug. 8, 2011 and No. 10-2012-0035209 filed on Apr. 5, 2012 in the Korean Intellectual Property Office (KIPO), the entire contents of which are hereby incorporated by reference.

### BACKGROUND

1. Technical Field

Example embodiments of the present invention relate in general to a method and apparatus for providing video service, and more specifically to a method and apparatus for providing seamless real-time video services in a wired, wireless or wired/wireless hybrid communication network.

2. Related Art

If a wired or wireless channel used in multimedia packet communication deteriorates, an erroneous packet generation rate can increase. The reason is that if a delay occurs due to excessive traffic at a router in a wired environment and thus packets do not arrive on time, video cannot be displayed and the packets are treated as loss packets. In a wireless environment, packet loss can increase by an increase in packet errors due to channel fading, etc. To make up for this, a retransmission technique using ARQ (Automatic ReQuest) or HARQ (Hybrid ARQ) can be used, but it can cause a delay. Thus, while there is no problem with non-real-time services, such as reproducing video downloaded previously and stored, there can be problems with real-time services, such as interactive video or video conference calls.

For example, packet loss can cause great problems in high-definition real-time video services with relatively high data transfer rates, such as supervision for factory maintenance, information exchange among machine experts in a factory using 3D video, or providing 3D medical video services for urgent patients and other patients on islands or in isolated areas. Thus, the problem of packet loss in communication channels has to be solved.

As a typical technique for coping with packet loss, AL-FEC (Application Layer Forward Error Correction) is used. This technique increases redundancy to increase coding rates as packet loss increases. In order to increase redundancy, code rates are determined adaptively for channels at receiving ends using rate-less codes, such as Fountain Code, or the redundancy of AL-FEC at transmitting ends is controlled by notifying of the states of channels through feedback from lower layers to the transmitting ends using a concept of a receiving application layer or a cross layer. However, such a technique can decrease the transfer rate of source video and thus definition, since the overall transfer rate including AL-FEC should be uniformly maintained.

### SUMMARY

Accordingly, example embodiments of the present invention are provided to substantially obviate one or more problems due to limitations and disadvantages of the related art.

Example embodiments of the present invention provide a method for providing video service that decreases packet loss but does not decrease transfer rate.

Example embodiments of the present invention also provide an apparatus for providing video service that decreases packet loss but does not decrease transfer rate.

In some example embodiments, a method of providing video service which is performed by a server providing the video service includes determining based on a predetermined reference whether it is necessary to set multiple bearers to provide video service for a terminal (first step); and when it is determined necessary to set multiple bearers, setting an additional bearer, dividing a video source stream into a first stream and a second stream, assigning the first and second streams to a default bearer and the additional bearer, respectively, and transmitting the first and second streams to the terminal (second step).

If a request signal for urgent service is received from the terminal, it may be determined that it is necessary to set multiple bearers.

It may be determined based on the IP address of the terminal whether it is necessary to set multiple bearers.

It may be determined based on at least one of multiple bearer assigning history and channel quality history of the terminal whether it is necessary to set multiple bearers.

It may be determined based on feedback information supplied from the terminal whether it is necessary to set multiple bearers, wherein the feedback information includes information on at least one of the display buffer state of the terminal, reception link quality from a network layer, link quality information received from a link layer and link quality information received from a physical layer through CLO (Cross Layer Optimization).

The method may further include preliminarily setting an additional bearer according to a predetermined procedure prior to the second step, if it is necessary to set multiple bearers, and in the second step, assigning predetermined resources to the preliminarily set additional bearer to set the additional bearer.

The first stream may include odd frames of the video source stream and the second stream may include even frames of the video source stream.

In other example embodiments, a method of providing video service that is performed by a terminal receiving the video service from a server includes requesting urgent service from the server if a predetermined value is input through a user interface on the terminal, and receiving video streams transmitted through an additional bearer assigned in response to the request for urgent service from the server.

Receiving the video streams may include receiving two video streams that are respectively transmitted through two bearers in response to the urgent service request from the server, wherein one of the two video streams includes odd frames of a video source stream and the other video stream includes even frames of the video source stream.

In yet other example embodiments, an apparatus for providing video service on a terminal includes a frame dividing unit for dividing and outputting a video source stream into a first stream including odd frames and a second stream including even frames, and a transmitting unit for assigning the first and second streams to separate bearers respectively and transmitting the first and second streams to the terminal.

The apparatus may operate when a signal requesting urgent service is received from the terminal or when it is determined based on a predetermined reference that the terminal needs multiple bearer service.

In yet other example embodiments, a terminal receiving video service from a server includes a user interface for requesting urgent service from the server and a receiving unit for receiving video streams transmitted through an additional bearer assigned in response to the urgent service request from the server.

According to the method and apparatus for providing video service of the present invention, a user is provided with a user interface to be able to urgently request a high-quality real-time video service, and thus high-quality video service requiring many resources can be selectively provided only when necessary. In addition, according to the present invention, video service providing server itself determines whether to provide a terminal with a seamless high-quality video service, and thus communication resources are efficiently used and, at the same time, optimal performance is ensured. In addition, according to the present invention, a special source coding technique called DDC (Double Description Coding) and a communication technique called a double bearer are applied to seamlessly provide a high-quality 3D video service, and thus improved performance and route diversity can be achieved.

### BRIEF DESCRIPTION OF DRAWINGS

These and other objectives, features and advantages of the present invention will become more apparent by describing in detail example embodiments of the present invention with reference to the accompanying drawings, in which:

FIG. 1 is a flowchart illustrating a process of providing video service from a video server to a terminal according to one example embodiment of the present invention;

FIG. 2 is a flowchart illustrating a process of providing video service at a terminal according to one example embodiment of the present invention;

FIG. 3 is a flowchart illustrating a process of providing video service from a video server to a terminal according to another example embodiment of the present invention;

FIG. 4 is a conceptual diagram illustrating a process of determining whether to assign a double bearer based on an IP address according to one example embodiment of the present invention;

FIG. 5 is a conceptual diagram illustrating a process of determining whether to assign a double bearer based on communication history according to one example embodiment of the present invention;

FIG. 6 is a conceptual diagram illustrating a process of preliminarily setting an additional bearer according to one example embodiment of the present invention;

FIG. 7 is a conceptual diagram illustrating a system for providing double bearer video service using a DDC (Double Description Coding) technique according to one example embodiment of the present invention;

FIG. 8 is a conceptual diagram illustrating a system for providing single bearer video service using an SDC (Single Description Coding) technique, to compare performance with the system in FIG. 7;

FIG. 9 is a graph comparing PSNR (Peak Signal to Noise Ratio) performance of an SDC-based single bearer video service system with a DDC-based double bearer video service system;

FIG. 10 is a conceptual diagram illustrating a communication structure between a server and a terminal in a video service system in an IP and 3GPP hybrid network; and

FIG. 11 is a conceptual diagram illustrating a communication structure between one terminal and another terminal in a video service system in an IP and 3GPP hybrid network.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific example embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular example embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

A method and an apparatus for providing video service according to the present invention are disclosed below.

The present invention relates to a technology for a high-definition seamless multimedia communication service in a wired, wireless, or wired/wireless hybrid communication network, and discloses a method and a technique of efficiently using communication resources with low complexity while satisfying the requests/needs of a user. In particular, a method of providing video service according to one example embodiment of the present invention involves providing a multimedia service in a hybrid network of the Internet and a 3GPP LTE network. The present invention applies a special coding technique called DDC (Double Description Coding) and a communication technique called a double bearer to seamlessly provide a high-quality 3D video service through a public network, such as the IP network, where quality is not guaranteed.

When providing a 3D video service at a high data rate, there may be a problem with channel capacity especially in the case of a high-quality service. The DDC technique presented by the present invention enables, in the worst case, poor definition with seamless natural reproduction rather than high definition with interruptions in reproduction.

With reference to the attached drawings, example embodiments of the present invention are described in detail. For ease in obtaining a thorough understanding of the present invention, Elements of the example embodiments are consistently denoted by the same respective reference numerals throughout the drawings and detailed description, and descriptions of elements are not repeated.

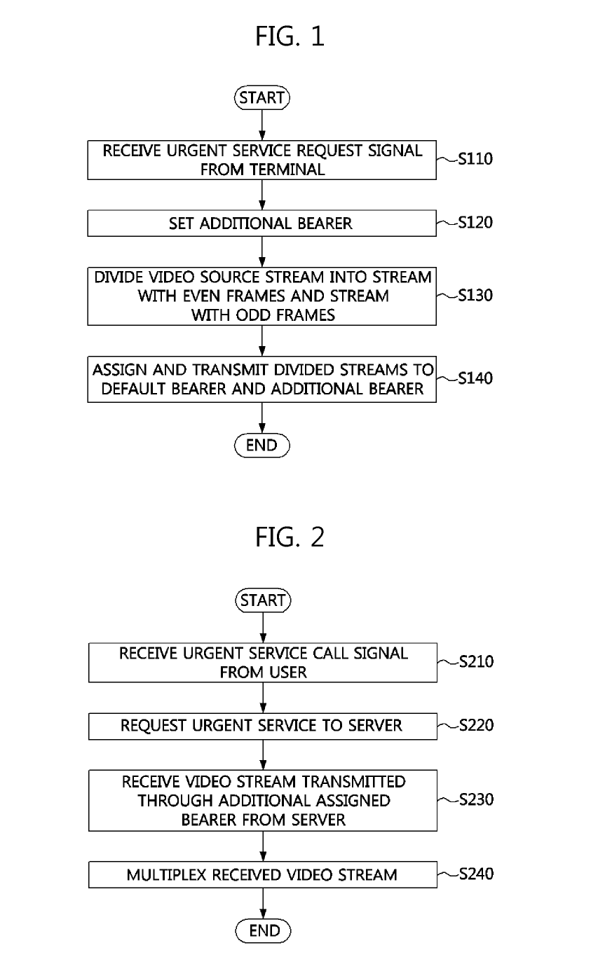

FIG. 1 is a flowchart illustrating a process of providing video service from a video server to a terminal according to one example embodiment of the present invention.

Referring to FIG. 1, the process of providing video service from a video server to a terminal according to one example embodiment of the present invention may include receiving urgent service request signal (S110), setting an additional bearer (S120), dividing a stream (S130), and transmitting a stream (S140).

Still referring to FIG. 1, each step of the process of providing video service according to one example embodiment of the present invention can be described as follows.

Receiving urgent service request signal (S110) may include receiving a signal requesting urgent provision of service due to a decrease in quality while using video service from a terminal receiving the video service.

For example, if a predetermined value is input through a user interface on a terminal receiving a real-time video service, then the terminal may send urgent service request signal to the server. In order words, if frequent interruption occurs or definition decreases and noise increases while a user uses the video service, then the user presses a soft or hard key type button on the terminal to request urgent service and the terminal sends urgent service request signal to the server, correspondingly.

Setting an additional bearer (S120) may include setting an additional bearer to provide high-quality video service when the urgent service request signal is received from the terminal.

Dividing a stream (S130) may include dividing a video source stream into two streams. Here, the video source stream may be divided into a first stream including odd frames and a second stream including even frames. That is, a DDC (Double Description Coding) technique can be used to avoid redundant assignment of a previously set bearer and another bearer further set in (S120) and thereby increase transfer efficiency.

Transmitting a stream (S140) may include assigning each stream divided in (S130) to a default bearer and the additional bearer and transmitting the streams to the terminal requesting urgent service.

A case in which a user, determining that urgent service is needed while using video service provided from the server, operates a terminal to request improvement of service quality and is thereby provided with double bearer service is described below with reference to the drawings.

FIG. 2 is a flowchart illustrating a process of providing video service at a terminal according to one example embodiment of the present invention.

Referring to FIG. 2, a process of providing video service according to one example embodiment of the present invention may include receiving urgent service call signal according to a method of providing video service in a terminal using a service provided from a video server (S210), requesting urgent service (S220), receiving a video stream (S230), and synthesizing the video stream (S240).

Referring also to FIG. 2, each step of the process of providing video service according to one example embodiment of the present invention can be described as follows.

Receiving urgent service request signal (S210) may include receiving a service call signal from a user through a user interface on a terminal. For example, if frequent interruption occurs or definition decreases and noise increases while a user uses a real-time video service, then the user presses a soft or hard key type button or a predetermined key on the terminal using the video service to request urgent service, and the terminal can recognize that urgent service call signal has been received and perform a corresponding operation.

Requesting urgent service (S220) may include requesting urgent service from video service providing server in the event that urgent service call signal is received from the user.

Receiving a video stream (S230) may include receiving a video stream transmitted through an additional bearer assigned in response to the urgent service request made in (S220). Here, the video stream received from the server may be two video streams that are respectively transmitted through two bearers that are a default bearer and an additional bearer assigned in response to the urgent service request. In addition, the two video streams may be generated by dividing a video source stream into even and odd frames.

Multiplexing a video stream (S240) may include multiplexing the two received video streams respectively including even frames and odd frames.

One example embodiment of providing video service by a video server itself determining whether double bearer service is needed is described below with reference to the drawings.

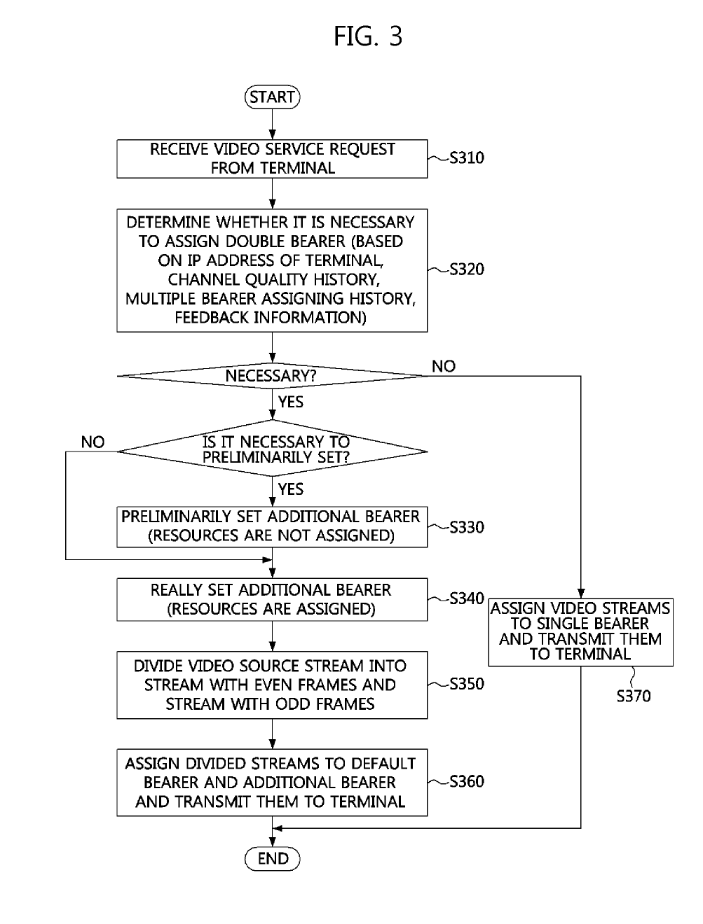

FIG. 3 is a flowchart illustrating a process of providing video service from a video server to a terminal according to another example embodiment of the present invention.

Referring to FIG. 3, steps of a process of providing video service from a video server to a terminal according to another example embodiment of the present invention may include receiving a request for service (S310), determining whether double bearer assignment is necessary (S320), preliminarily setting an additional bearer (S330), setting the additional bearer (S340), dividing a stream (S350), and performing double bearer assignment and transfer (S360).

Still referring to FIG. 3, each step of the process of providing video service according to another example embodiment of the present invention can be described as follows.

Receiving the service request (S310) may include receiving a request to provide video service from the terminal.

Determining whether double bearer assignment is necessary (S320) may include determining based on a predetermined reference whether double bearer assignment is necessary to provide the video service to the terminal requesting the video service.

Here, the predetermined reference may include information on at least one of the terminal's location, the terminal's channel quality history, multiple bearer assigning history, and feedback sent from the terminal while service is provided. For example, if it is determined with reference to the IP address of the terminal that the terminal is located far away from the server, double bearer assignment may be considered. Alternatively, if it is determined with reference to the communication history of the terminal that the channel quality is below a reference or the assigned number of multiple bearers is more than a reference, double bearer assignment may be considered.

As another example, a determination may be made based on feedback information provided from the terminal receiving service. The feedback information may include at least one of video display buffer state information of a terminal and reception link quality information from a network, link or physical layer through CLO (Cross Layer optimization). A method of determining whether double bearer assignment is necessary will be described in more detail later.

If it is determined that double bearer assignment is necessary, then preliminarily setting an additional bearer (S330), setting the additional bearer (S340), dividing a stream (S350), and performing double bearer assignment and transfer (S360) may be performed. If it is determined that double bearer assignment is not necessary, the video stream assigned to a single bearer may be transmitted to the terminal (S370).

Preliminarily setting an additional bearer (S330) may include adding and preliminarily setting an additional bearer to a default bearer. Here, a time-consuming operation of setting the additional bearer may be performed. However, an operation of actually assigning resources may be performed in the step of setting an additional bearer (S340).

Setting an additional bearer (S340) may include setting another bearer in addition to the default bearer. If an additional bearer is preliminarily set, then operations following the pressing operation may be carried out. Operations relating to preliminarily setting and setting a bearer may be carried out according to a predetermined procedure. Setting an additional bearer may include actually assigning resources to the additional bearer. In addition, if an additional bearer is not preliminarily set, all operations to set the additional bearer may be carried out through setting the additional bearer. Preliminarily setting and setting of an additional bearer are described in more detail later.

Dividing a stream (S350) may include dividing a video source stream into two streams. Here, the video source stream may be divided into a first stream including odd frames and a second stream including even frames. In other words, a DDC (Double Description Coding) technique may be used to avoid redundant assignment to an additional bearer set through setting an additional bearer (S340) and a default bearer, and thereby increase transfer efficiency.

Performing double bearer assignment and transfer (S360) may include respectively assigning the streams resulting from division in (S350) to the default bearer and the additional bearer and transmitting the streams to the terminal requesting urgent service. According to example embodiments of the present invention described above, a double bearer setting technique and a DDC technique can be used to satisfy the quality needs of real-time 3D video service. However, since setting a double bearer increases resource needs and system complexity, it is not desirable to perform unnecessary operations. Thus, a video service providing system itself determines whether it is necessary to enhance quality in order to provide a real-time multimedia service, and the double bearer setting and DDC techniques may be applied only if it is determined necessary to enhance quality. A variety of references may be applied to determine whether it is necessary to set the double bearer, as described below with reference to the drawings.

1) Reference to the IP Address of a Terminal Using Video Service

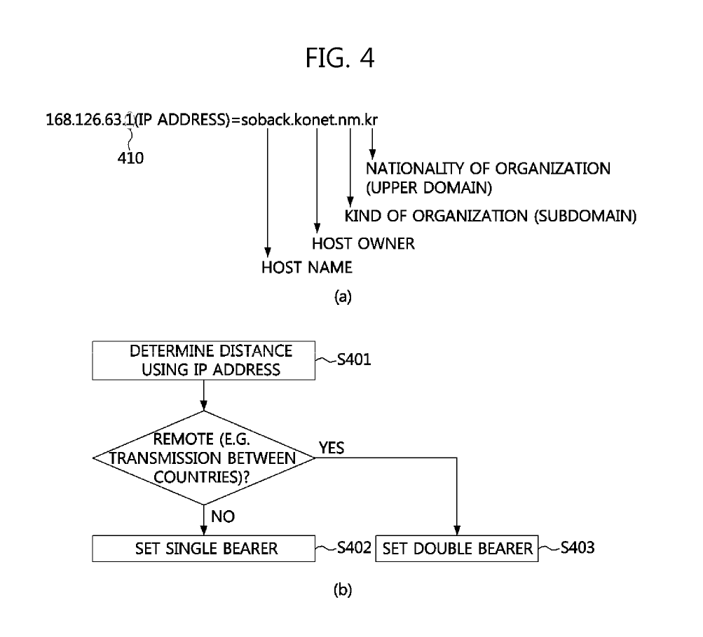

FIG. 4 is a conceptual diagram illustrating a process of determining whether to assign a double bearer based on an IP address according to one example embodiment of the present invention.

Referring to FIG. 4(a), a part 410 represents a country corresponding to an IP address. In long-distance communication, such as communication between countries or between continents, a delay is likely to increase due to router congestion caused by an increase in traffic in a wired section. In this case, the delay can be prevented through route diversity by setting a double bearer.

In other words, a distance is determined based on the part 410 representing the country to which the IP address of the terminal corresponds (S401). If it is determined that the terminal is located far from the server, such as in the case of international communication, then a double bearer may be set (S403), but if not, a single bearer may be set.

2) Reference to the Communication History Between a Server and a Terminal

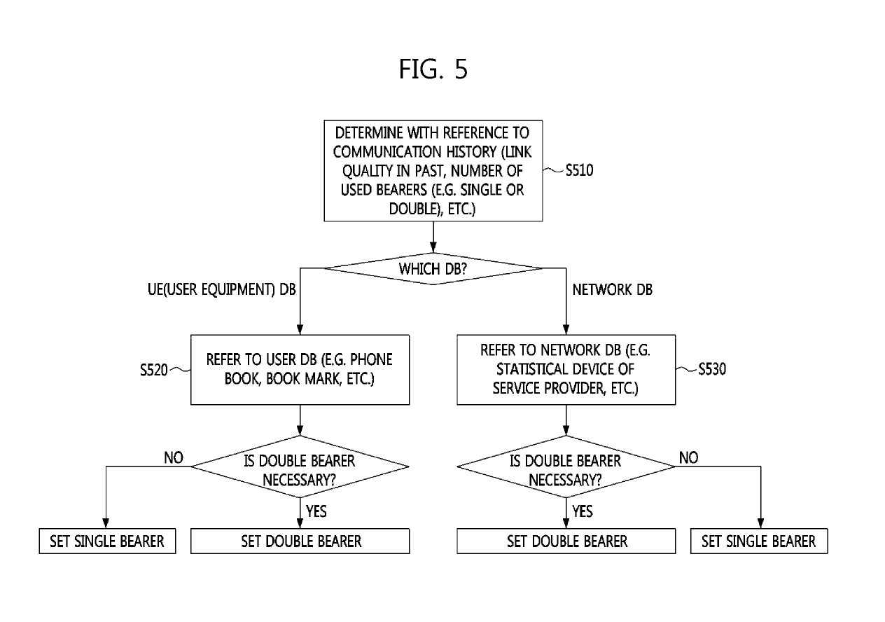

FIG. 5 is a conceptual diagram illustrating a process of determining whether to assign a double bearer based on communication history according to one example embodiment of the present invention.

Referring to FIG. 5, reference to the communication history of a terminal managed by a database may be made to determine whether to assign a double bearer. For example, reference may be made to a database where a channel (link) quality history or a (single or double) bearer assigning history in real-time communication services was stored in the past.

If the communication history of a terminal has been recorded and managed on the bookmark of a user terminal (for MBMS, PSS, HTTP, streaming service) or on a phone book (for MTSI (Multimedia Telephony Service for IMS)), whether to set a double bearer or a single bearer may be determined by referring to a user database (S520).

Alternately, whether to set a single bearer or a double bearer can be determined by recording and managing a communication history on a network database managed by a service provider, and referring to the database whenever a request is made (S530).

3) Reflection of Feedback from a Terminal

As another example of determining whether it is necessary to set a double bearer to provide video service, there is a method of determining whether it is necessary to set multiple bearers based on feedback information supplied from a terminal. Here, the feedback information may include at least one of video display buffer state information of a terminal using video service and reception link quality information from a network, link or physical layer through CLO. The method includes receiving feedback information, such as information on a video display buffer state of a terminal on a receiving side and determining by a transmitting-side server whether to set a double bearer. In addition, whether it is necessary to set an additional bearer may be determined with reference to feedback information on link quality sent from the network, link or physical layer through CLO or the like, as well as the buffer state of the terminal.

For example, the number of bearers in a communication service may be predefined as a system state. In other words, the default state of a system may be set as a single bearer and then switched to a double bearer or vice versa.

4) Preliminarily Setting an Additional Bearer

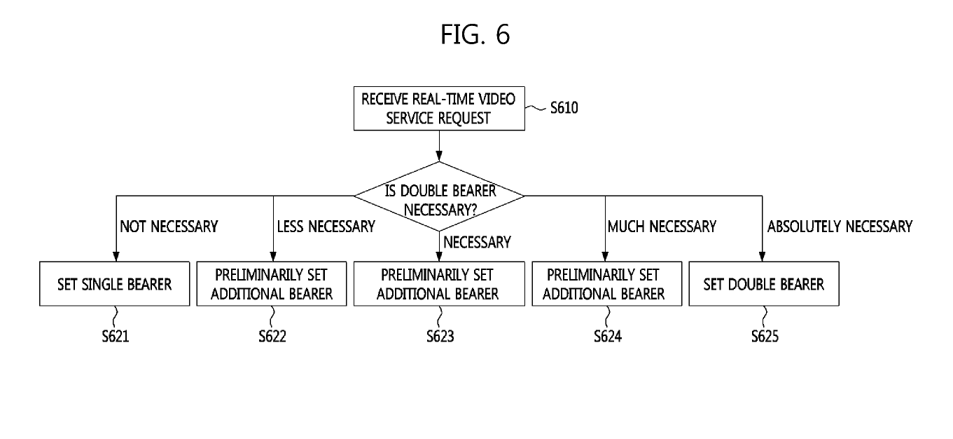

FIG. 6 is a conceptual diagram illustrating a process of preliminarily setting an additional bearer according to one example embodiment of the present invention.

Referring to FIG. 6, the necessity of a double bearer may be determined in a statistical or probabilistic way and an additional bearer may be preliminarily set according to statistical frequency or a probability of requiring the double bearer (S621) to (S625). The preliminary setting of a bearer can save communication resources in comparison to real setting and can function as an efficient means for enhancing service quality by rapidly carrying out real bearer setting based on the preliminary setting, if necessary. Here, a method of determining the necessity of the double bearer may refer to the communication history or IP address of a terminal, as described with reference to FIGS. 4 and 5.

Particular procedures and steps for the preliminary setting of an additional bearer may follow a bearer setting procedure for each system. However, a procedure to be performed in the preliminary setting step and a step to be added in the real setting step are predefined, and the preliminary setting and the real setting may be performed according to the predefined procedures. Here, the preliminary setting and real setting procedures may be defined according to a probability of requiring the double bearer.

On the other hand, procedures for preliminarily and really setting a bearer may follow the following reference. In other words, the preliminary setting procedure may include operations that take as much time as possible and do not requiring resource assignment. The real setting procedure may include operations that take little time and require final resource assignment.

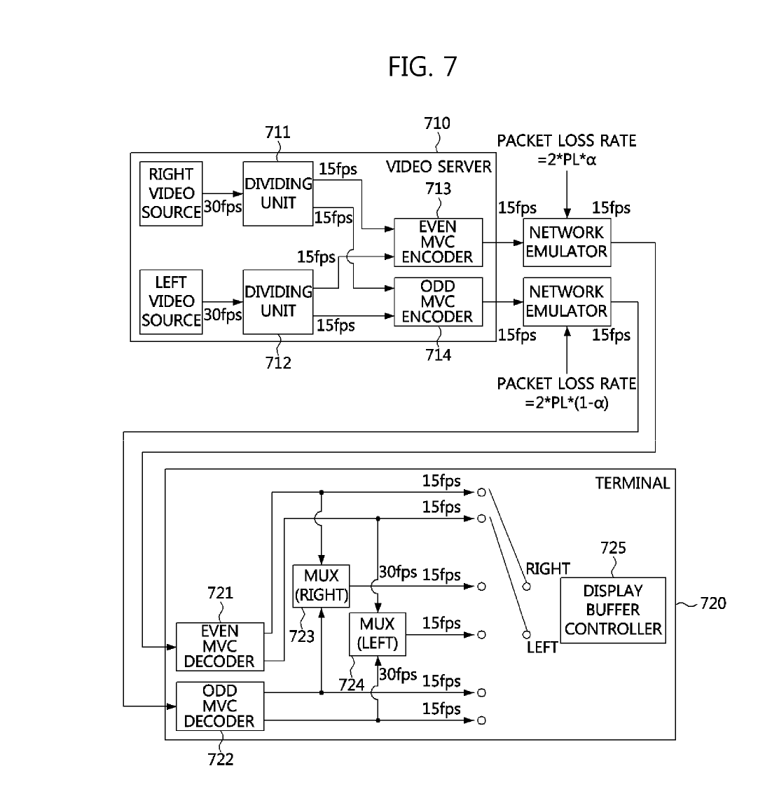

FIG. 7 is a conceptual diagram illustrating a system for providing double bearer video service using a DDC technique according to one example embodiment of the present invention.

Referring to FIG. 7, a system for providing video service according to one example embodiment of the present invention may include a video server 710 for providing video service and a terminal 720 using video service provided from the video server.

The video server 710 may include a right video dividing unit 711 for dividing frames of a right video source into even and odd frames and a left video dividing unit 712 for dividing the frames of a left video source into even and odd frames. In addition, the video server 710 may include an even MVC encoder 713 and an odd MVC encoder 714, which respectively encode the even frames and odd frames divided by the left video dividing unit 711 and the right video dividing unit 712. The video streams that are divided into the even and odd frames and encoded may be assigned to individual respective bearers and transmitted to a terminal.

The terminal 720 may include an even MVC decoder 721 and an odd MVC decoder 722 that receive two video streams assigned to a double bearer and transmitted and decode them respectively. In addition, the terminal may include a right MUX 723 and a left MUX 724 that respectively extract a left video frame and a right video frame from the video stream decoded from the even MVC decoder 721 and the odd MVC decoder 722, and a display buffer controller 725 that controls display depending on packet quality of a received GoP.

The following Table 1 shows GOP packet events and corresponding operations that may occur on a terminal 720 receiving DDC streams.

TABLE 1

| Even MVC | Odd MVC | |
|---|---|---|
| Output GOP | Output GOP | Display Buffer |
| Packet Quality | Packet Quality | Controller Operation |
| GOOD | GOOD | MUX Even/Odd GOP |
| GOOD | BAD | Receive Only Even GOP (Repeat) |
| BAD | GOOD | Receive Only Odd GOP (Repeat) |
| BAD | BAD | Conceal Errors on Corresponding |
| | | GOP (Error Concealment) |

As described above, the video service providing system according to one example embodiment of the present invention considers the effects of additionally obtaining communication resources and of route diversity through setting a double bearer. In addition, using an MDC technique, the system may avoid wasting resources transmitting the same information via different routes. As one example of the MDC technique, the video server 710 of the present invention may reduce a frame rate by dividing the frame rate of a video source into even frames and odd frames and coding each stream separately. This is called DDC in the present invention.

The DDC streams assigned and transmitted to each bearer may have the same QoS (Qaulity of Service) or different QoS. In other words, it may be set such that the DDC stream transmitted to a basic bearer has recommended QoS and the DDC stream transmitted to an additional bearer has higher or lower QoS. In addition, if double bearer service is used to provide real-time 3D video service, the DDC technique above may be used and the Fountain Code technique may also be used. The Fountain Code technique can recover sources even if a terminal receives different fountain codes after the same source packets are transmitted to the basic and additional bearers and fountain codes are generated on an AL-FEC processing layer. The Fountain Code technique of the present invention is similar to a case of using route diversity and Fountain Code in P2P.

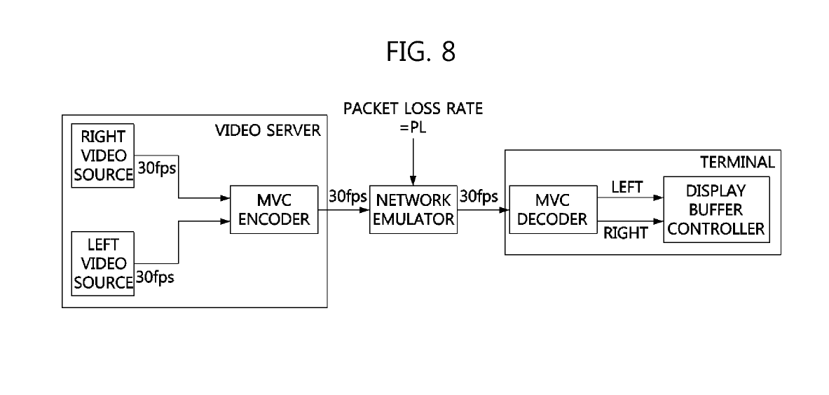

FIG. 8 is a conceptual diagram illustrating a system for providing single bearer video service using a SDC (Single Description Coding) technique, to compare performance with the system in FIG. 7.

Referring to FIG. 8, the video service system in FIG. 8 has a structure corresponding to a system for providing double bearer video service using a DDC technique in FIG. 7, and is a system for providing single bearer video service using an SDC technique.

A computer simulation was carried out to compare the performance of the DDC-based double bearer system according to the present invention with that of the single bearer system in FIG. 8. If packets arrive in a certain time, assuming that a packet arrival time has an exponential distribution in the computer system, then they become useless data in real-time video display. Thus, a probability of such a event occurring is defined as a packet loss rate.

Table 2 below shows information on a source data rate, a source encoding (channel) data rate, etc. in a case of providing single bearer service using an SDC technique.

TABLE 2

| | | | Speed | |
|---|---|---|---|---|
| Video | | | (Byte/ | Speed |
| Data | Fine name | Total File size | sec) | (Bit/sec) |
| Right | Balloons_0.yuv | 50.625M/15 sec | 3.375M | 27M |
| Source | | | | |
| Left | Balloons_1.yuv | 50.625M/15 sec | 3.375M | 27M |
| Source | | | | |
| Total | | 101.250M/15 sec | 6.75M | 54M |
| MVC | Enc_test.264 | 4.052M/15 sec | 270.1K | 2.1611M |
| Encoded | | | | |
| Packetized | test_mux.bs | 4.067M/15 sec | 271.1K | 2.1691M |
| (Header | | | | |
| Inserted) | | | | |

Table 3 below shows information on a source data rate, a source encoding (channel) data rate, etc. in a case of providing double bearer service using a DDC technique.

TABLE 3

| | | | Speed | Speed |
|---|---|---|---|---|
| Video Data | Fine name | Total File size | (Byte/sec) | (Bit/sec) |
| Right Source (E) | Balloons_0_even.yuv | 25.313M/15 sec | 1.6875M | 13.5M |
| (Odd) | Balloons_0_odd.yuv | 25.313M/15 sec | 1.6875M | 13.5M |
| Left Source | Balloons_1_even.yuv | 25.313M/15 sec | 1.6875M | 13.5M |
| (Odd) | Balloons_1_odd.yuv | 25.313M/15 sec | 1.6875M | 13.5M |
| Total | | 101.252M/15 sec | 6.7501M | 54.0011M |
| MVC Encoded | Enc_test_even.264 | 2.040M/15 sec | 136K | 1.088M |
| (Odd) | Enc_test_odd.264 | 2.016M/15 sec | 134.4K | 1.0752M |
| Total | | 4.056M/15 sec | 270.4K | 2.1632M |
| Packetized | test_mux_even.bs | 2.048M/15 sec | 136.5K | 1.0923M |
| (Header Inserted) | | | | |
| (Odd) | test_mux_odd.bs | 2.024M/15 sec | 134.9K | 1.0795M |
| Total | | 4.072M/15 sec | 271.5K | 2.1717M |

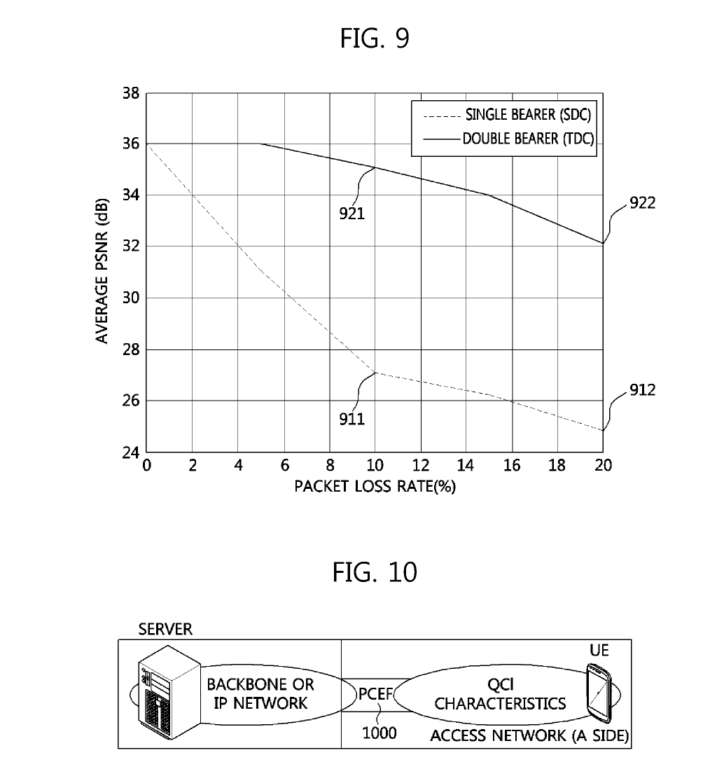

Comparing the code rates of SDC and DDC shown in Tables 3 and 4, 2.1717 Mbps/2.1691 Mbps=1.001, so the code rate using DDC is higher by only about 0.001. However, there is a large difference in PSNR (Peak Signal to Noise Ratio) performance that will be described with reference to FIG. 9.

FIG. 9 is a graph comparing the PSNR performance of an SDC-based single bearer video service system with a DDC-based double bearer video service system.

Referring to FIG. 9, with 10% packet loss, the double bearer was about 35 dB 921 and the single bearer was about 27 dB 911, so the double bearer showed better PSNR performance by about 8 dB. On the other hand, with 20% packet loss, the double bearer was about 32 dB 922 and the single bearer was about 25 dB 912, so the double bearer showed better PSNR performance by about 7 dB. Here, a was 0.5, which is worst, and can be typically improved to over 15 dB. Thus, it was proven that high-definition real-time 3D video transmission service can be seamlessly provided through DDC-based double bearer setting by a real-time video urgent-service request.

The reason that the double bearer shows better PSNR performance by about 7 to 8 dB in FIG. 9 is owing to route diversity. Assuming that error of each route or a probability that a packet arrives later than a desired time and thus is discarded is 10%, that is 0.1, a simultaneous delay probability is 0.1×0.1=0.01, that is, it decreases to 1%. Thus, the packet loss rate decreases as the square of delay probability.

An example in which high-quality video service is provided using a video service system according to the present invention and a user is charged is described below.

As described above in FIGS. 1 and 2, a user interface (soft or hard keys) may be prepared on a terminal so that a user can request service directly if high-quality 3D video service is needed only for a certain time during a phone conversation, and a service provider receiving the request from the user can provide seamless high-definition 3D video service. In addition, billing should be carried out for a system function added to the service.

In addition, as described with reference to FIG. 3, if the system automatically detects and provides seamless high-definition 3D video service, then billing should be carried out for a corresponding service.

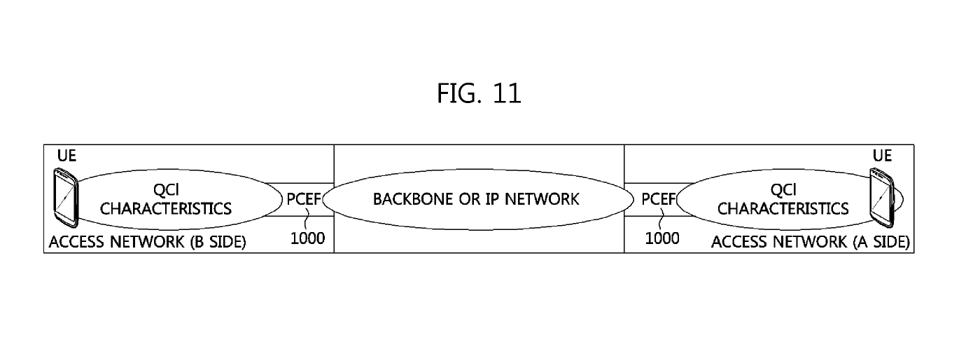

FIGS. 10 and 11 show a high-quality 3D video service system structure in a hybrid network of an IP network and a 3GPP LTE network.

Referring to FIGS. 10 and 11, a PCEF (Policy and Charging Enforcement Function) 1000 is responsible for a billing function in a 3GPP LTE system, and billing can be added according to QCI (QoS Class Identifier) features of a user terminal since more resources are assigned in a wireless environment as well as a wired environment when setting a double bearer.

As one example, if it is necessary to transmit and receive high-definition real-time 3D video including operating states and structural changes of machines to enable supervisors or experts to discuss quality control and machine maintenance in a factory, a user can press a key (a soft or hard key) on his terminal and request urgent high-definition 3D video transmission service or urgent service. Alternatively, a system itself can determine a service situation for a premium service subscriber and provide high-definition 3D video transmission service (e.g. DDC-based double bearer service according to the present invention).

As another example, if it is necessary to transmit and receive e-medical high-definition 3D video between medical experts located offshore or in isolated areas or urgent aid sites, a user can press a key (a soft or hard key) on his terminal and request urgent high-definition 3D video transmission service or urgent service. If the user is a premium service subscriber, then the system itself can determine a service situation and provide high-definition 3D video transmission service (e.g. DDC-based double bearer service according to the present invention). Thus, a service provider can charge the user.

As another example, if workers responsible for quality control and machine maintenance in a factory or a production field find that a machine is operating abnormally, they can connect to a 3D video server associated with machine maintenance with a 3D video mobile phone, check whether the machine has a problem, and take necessary measures. Here, the workers can request seamless high-definition 3D video service using an urgent-service request button on the terminal to minimize financial loss. Alternatively, if the user is a premium service subscriber, the system itself can make the determination and provide high-definition 3D service. In addition, the system may charge the user as compensation for providing the service.

As another example, unskilled medical workers in an emergency can connect to a medical server with their mobile phones to view 3D video for guidance in diagnosis and treatment based on patient symptom or affected areas. Here, the workers can press an urgent-service request button on the terminal to request seamless high-definition 3D video transmission service in order to prevent loss of life. Likewise, if the user is a premium service subscriber, the system should provide seamless high-definition 3D video service. A service provider thus charges according to a provided service.

Although the technology according to the present invention described above can be used for both MBMS (Multimedia Broadcast/Multicast Service) and PSS (Packet-Switched Streaming), it is especially suitable for MTSI (Multimedia Telephony Service for IMS, IMS=IP Multimedia Subsystem, IP=Internet Protocol) and a remote video conference system that requires real-time service.

However, the present technology can be generally applied without limitation in the areas described above, and all methods that can be generally applied also fall within the scope of the present invention. For convenience, the present technology is described above as being fully interconnected with a wired/wireless network including a video layer, however the present technology can be used via partial or full interconnection with a network.

While example embodiments of the present invention and their advantages have been described in detail, it should be understood that various changes, substitutions and alterations may be made herein without departing from the scope of the invention.

What is claimed is:

1. A method of providing video service which is performed by a server providing the video service, comprising:
determining based on a predetermined reference whether it is necessary to set multiple bearers to provide the video service for a terminal; and
setting an additional bearer when it is determined necessary to set the multiple bearers, dividing a video source stream into a first stream and a second stream, assigning the first and second streams to a default bearer and the additional bearer, respectively, and transmitting the first and second streams to the terminal.

2. The method of claim 1, wherein in determining based on a predetermined reference, it is determined necessary to set the multiple bearers when a request signal for urgent service is received from the terminal.

3. The method of claim 1, wherein in determining based on a predetermined reference, whether it is necessary to set the multiple bearers is determined based on an IP address of the terminal.

4. The method of claim 1, wherein in determining based on a predetermined reference, whether it is necessary to set the multiple bearers is determined based on at least one of multiple bearer assigning history and channel quality history of the terminal.

5. The method of claim 1, wherein in determining based on a predetermined reference, whether it is necessary to set the multiple bearers is determined based on feedback information supplied from the terminal, and
the feedback information includes at least one of display buffer state information of the terminal, link quality information received from a network layer, link quality information received from a link layer, and link quality information received from a physical layer through CLO (Cross Layer Optimization).

6. The method of claim 1, further comprising:
before setting an additional bearer, preliminarily setting the additional bearer according to a predetermined procedure, when it is determined necessary to set the multiple bearers,
wherein in setting an additional bearer, predetermined resources are assigned to the preliminarily set additional bearer.

7. The method of claim 1, wherein in setting an additional bearer, the first stream includes odd frames of the video source stream and the second stream includes even frames of the video source stream.

8. A method of providing video service which is performed by a terminal receiving the video service from a server,
requesting urgent service to the server if a predetermined value is input through a user interface on the terminal; and
receiving video streams transmitted through an additional assigned bearer from the server as a response to the requested urgent service.

9. The method of claim 8, wherein receiving video streams comprises:
receiving two video streams that are respectively transmitted through two bearers from the server as a response to the requested urgent service,
wherein one of the two video streams includes odd frames of a video source stream and the other of the two video streams includes even frames of the video source stream.

10. The method of claim 9, further comprising:
outputting a left video stream and a right video stream by multiplexing the two received video streams.

11. A video service providing apparatus for providing video service on a terminal, comprising:
a frame dividing unit for dividing and outputting a video source stream into a first stream including odd frames and a second stream including even frames; and
a transmitting unit for assigning the first and second streams to separate bearers respectively and transmitting the first and second streams to the terminal.

12. The video service providing apparatus of claim 11, wherein the video service providing apparatus is operated when a signal requesting urgent service is received from the terminal or when it is determined based on a predetermined reference that the terminal needs multiple bearer service.

13. A terminal receiving video service from a server, comprising:
a user interface for requesting urgent service to the server; and
a receiving unit for receiving video streams transmitted through an additional assigned bearer from the server as a response to the requested urgent service.

14. The terminal of claim 13, wherein the receiving unit receives two video streams that are respectively transmitted through two bearers from the server as the response to the requested urgent service, and one of the two video streams includes odd frames of a video source stream and the other of the two video stream includes even frames of the video source stream.

15. The terminal of claim 14, further comprising a multiplexer for multiplexing the two received video streams and outputting a left video stream and a right video stream.
